(19) United States
(12) Patent Application Publication
(10) Pub. No.: US 2009/0070565 A1
(43) Pub. Date: Mar. 12, 2009

(54) METHODS, SYSTEMS, COMPUTER PROGRAMS AND APPARATUS FOR CHANGING A PROCESSOR STATE

(75) Inventor: Roderick J. Bartlett, Reston, VA (US)

Correspondence Address: FITZPATRICK CELLA HARPER & SCINTO, 30 ROCKEFELLER PLAZA, NEW YORK, NY, 10112, US

(73) Assignee: Tellabs Reston Inc., Naperville, IL (US)

(21) Appl. No.: 11/853,486

(22) Filed: Sep. 11, 2007

(51) Int. Cl. G06F 9/318

(52) U.S. Cl. 712/229; 712/E09.035

(57) ABSTRACT

Methods, systems, computer programs and apparatus for changing a processor state. In example embodiments of the invention, software porting onto an operating system calls a library routine, which creates an illegal instruction for special values in parameter registers. An illegal instruction exception handler recognizes the illegal instructions for special values in parameter registers, and, upon detecting the illegal instruction, enables or disables an interrupt state of a CPU associated with the system.

### BACKGROUND OF THE INVENTION

1. Field of the Invention

The present invention relates generally to methods, systems, computer programs and apparatus for changing a processor state. More specifically, the present invention relates to computer programs that may effect a change in a CPU state, such as an interrupt state.

2. Description of the Related Art

Software originally designed for older operating systems often must be ported onto a newer operating system. In many instances, however, design differences between the older software and the newer operating system cause problems in the porting operation.

In one example, software designed for a simple operating system that does not support multiple privilege levels sometimes must be ported onto a new operating system that does support multiple privilege levels. During the porting operation, the older software may attempt to perform operations that the operating system views as illegal instructions, even though the operations are necessary to port the software. As a result, an interrupt state will be set upon the CPU, and the CPU will call an exception handler. The exception handler, viewing the instructions of the porting software as illegal, may then act to terminate the software's operations, thereby preventing the porting operation from being completed.

One way to prevent the system from the exception handler from stopping the porting operation is to disable the interrupt state of the CPU, so that the exception handler is not called in response to the porting software's requests for service. In most systems, supervisory mode privileges are required to disable the interrupt state of the CPU. Because the older software in the porting operation is designed for a simple operating system, however, it may only be granted user mode privileges on the new operating system. Thus, without having the supervisory privileges necessary to alter the interrupt state of the CPU, the porting software cannot disable an interrupt state of the CPU.

One method for dealing with such a problem of porting older software involves modifying a portion of the older software code, so that the software may run in supervisory mode during the porting operation on the new operating system. The software code, therefore, may disable interrupts from being generated by the operating system during the porting operation. Such an approach, however, necessitates communication between two halves of the software code, that is, the original part and the part designed to achieve supervisory mode. Such a modification to the software is complicated and takes time to implement.

### SUMMARY OF THE INVENTION

The present invention provides various methods, systems, computer programs and apparatus for effecting a change in a processor.

In one example embodiment of the invention, a method is provided for changing a state of a processor. The method includes creating an illegal instruction for special values in parameter registers, and changing the state of the processor in response to detecting the illegal instruction for special values in parameter registers.

In another example embodiment of the invention, computer software embodied in a medium readable by a processor is provided. The computer software comprises a library routine that can create an illegal instruction for special values in parameter registers. The computer software further comprises an illegal instruction exception handler that can detect the illegal instruction for special values in parameter registers, and enable or disable an interrupt state of the processor in response to detecting the illegal instruction for special values in parameter registers.

In yet another embodiment of the invention, a computer-readable storage medium storing a computer program that is executable by a computer is provided. The program comprises a first program code that creates an illegal instruction for special values in parameter registers. The program further comprises a second program code that receives the illegal instruction for special values in parameter registers and effects a change in a processor associated with the computer.

In a still further example embodiment of the invention, a data processing apparatus is provided. The apparatus comprises at least one storage medium storing a library routine and an illegal instruction exception handler. A processor is coupled to the at least one storage medium, and arranged to execute (i) the library routine to create an illegal instruction for special values in parameter registers, and (ii) the illegal instruction exception handler to change a state of the processor in response to the illegal instruction for special values in parameter registers.

### BRIEF DESCRIPTION OF THE DRAWINGS

FIG. 1 is a flow chart showing a method according to an example embodiment of the invention, wherein device driver software is ported onto an operating system.

FIG. 2 is a flow chart showing further blocks of the method according to the example embodiment of the invention shown in FIG. 1.

FIG. 3 is a flow chart showing a method according to another example embodiment of the invention, wherein diagnostic software is ported onto an operating system.

FIG. 4 is a block diagram of a computer system according to an example embodiment of the invention.

FIG. 5 is an architecture diagram of a processing apparatus according to an example embodiment of the invention.

FIG. 6 is a logical diagram according to an example embodiment of the invention.

### DETAILED DESCRIPTION OF THE INVENTION

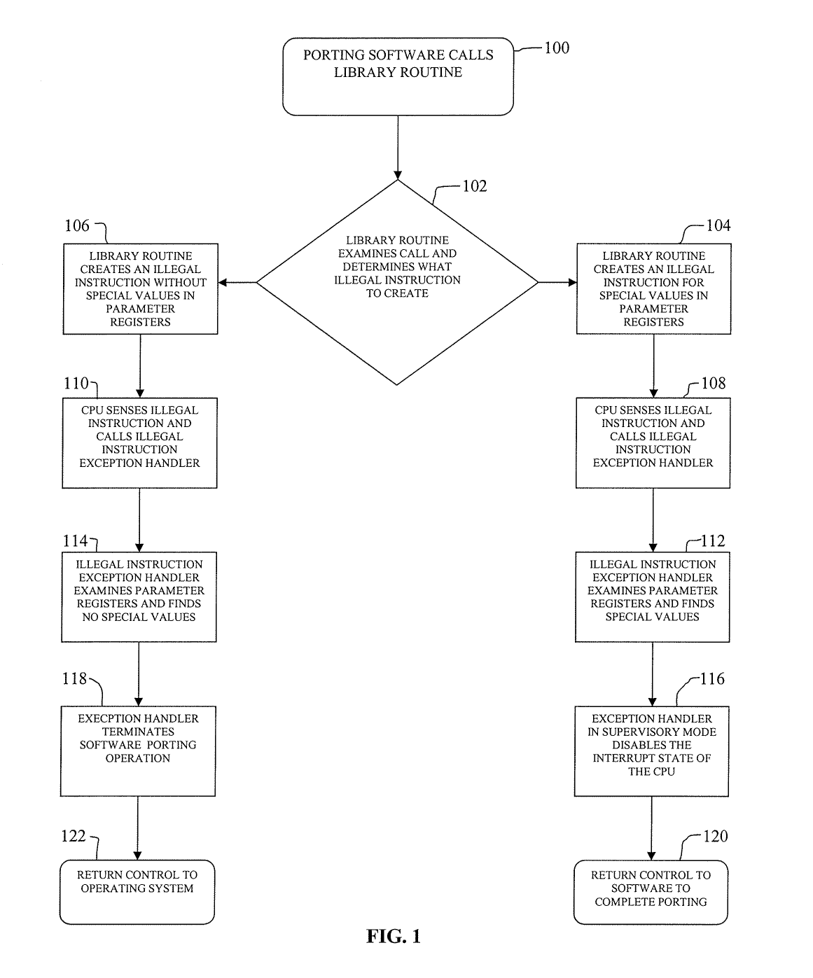

Computer-readable programs according to example embodiments of the invention will first be described, and then detailed example embodiments of the invention will be described in conjunction with FIGS. 1-6.

In one example aspect of the invention, a first computer-readable program is provided. In example embodiments, the first computer-readable program is a library routine. Hereinafter the first computer-readable program will be referred to for convenience as a library routine. It is understood, however, that the invention may be used with any computer-readable program that generally performs the functions described herein.

In example embodiments of the invention, the library routine may be an application programming interface. In general, the application programming interface may be selected in accordance with the particular operating system being used with the application programming interface. The application programming interface may be, for example, a source code interface that a computer application, operating system, or library provides to support requests for services to be made of it by any computer program. Specific examples of application programming interfaces that may be used include Linux Kernel API, Single UNIX Specification, Microsoft Windows Application Windows Interface, PC BIOS call interface, Java Platform APIs, Carbon and Coca for the Macintosh OS. Other library routines, or more specifically, other application programming interfaces, may be used as well.

The library routine is either initially coded, or subsequently modified, so as to be able to recognize a request for service, or a call, directed to a processor associated with the library routine. In example embodiments of the invention, the request for service may come from software. For example, the request may come from software attempting to port on an operating system associated with the library routine. The software may be of the type which does not support multiple privilege levels. As an example, software written for a Real Time Operating System (RTOS) may be used. One example of software that may be used in an example embodiment of the invention is device driver software, written for older operating systems, that does not include multiple privilege levels. In another example embodiment of the invention, diagnostic software may be used, which may or may not support multiple privilege levels. Other types of software may be used as well.

The library routine may be coded so as to be able to create an illegal instruction, which can load special values in parameter registers of the processor associated with the library routine, such as a CPU. This instruction will hereinafter be referred to as an “illegal instruction for special values in parameter registers.” Also, hereinafter the processor will be referred to as the CPU, although it is understood that embodiments of the invention may also be used with other types of processors as well. Further, the term “special” refers to any value of a parameter register that the elements of the system on which an embodiment of the invention is being practiced can recognize and associate as indicating the inventive operations described herein.

In example embodiments wherein the invention is used with software, the library routine may be coded to create the illegal instruction for special values in parameter registers upon receiving a call from specific software to be ported on the operating system associated with the library routine.

In an example embodiment of the invention, the library routine creates illegal instructions for special values in at least two parameter registers. In this example embodiment, one of the special value parameter registers may be used to indicate to an exception handler that the illegal instruction is intentional, as will be described below. In this example embodiment, another of the special value parameter registers may be used to communicate to the exception handler a request that the CPU interrupt state be either enabled or disabled. Other parameter registers of the illegal instructions may also include special values to indicate further instructions to an illegal instruction exception handler.

In an example embodiment of the invention wherein a PowerPC architecture is used, register R3 of an illegal instruction created by the library routine may be used for one of the special values. In such a case, the register R3 may contain, for example, the hexadecimal value 0x494e542a, which is equivalent to the characters “INT*.” This parameter registers may then be used to indicate to the illegal instruction exception handler that the illegal instruction exception being processed is an intentional one.

In another example embodiment of the invention wherein a PowerPC architecture is used, register R4 of an illegal instruction may also be used for one of the special values in parameter registers. In this case, the register may contain, for example, the hexadecimal value 0x4449532a, which is equivalent to the characters “DIS*.” This parameter register may then be used to indicate to the illegal instruction exception handler that the illegal instruction being processed is requesting that an interrupt state of the CPU be disabled. Similarly, register R4 of another illegal instruction may be used for the special value corresponding to the enabling of the CPU interrupt state. In such a case, the register may contain the hexadecimal value 0x454e412a, which is equivalent to the characters “ENA*.” This may then indicate to the illegal instruction exception handler that the illegal instruction being processed is requesting that the interrupt state of the CPU be enabled.

In various embodiments of the invention, the library routine may be coded to recognize a plurality of calls, and further create a plurality of instructions containing a plurality of unique parameter registers. That is, the invention in at least these example embodiments contemplates the application to any number of calls to the library routine, the creation of any number of instructions, and the use of any number of parameter registers with special values.

In another example aspect of the invention, another computer-readable program is provided. This computer-readable program may be, for example, an illegal instruction exception handler. This computer-readable program will be referred to hereinafter as an illegal instruction exception handler, although it is recognized that other types of computer-readable programs may be used as well that perform the general functions described below.

The illegal instruction exception handler may either be created, or the code of an existing illegal instruction exception handler may be modified so as to be able to recognize an illegal instruction for special values in parameter registers that is created by a library routine.

The illegal instruction exception handler may be able to interpret that a special value in a parameter register of an illegal instruction is indicating that the illegal instruction is intentional. For example, in the above described embodiments of the invention wherein software porting on an operating system generates a call to the library routine that creates an illegal instruction for special values in parameter registers, the illegal instruction exception handler may detect that the illegal instruction is in fact intentional, and the illegal instruction exception handler may thereby be configured not to automatically terminate the porting operation of the software.

The illegal instruction exception handler may also recognize that a special value in a parameter register of an illegal instruction indicates that the illegal instruction exception handler should disable, or enable, an interrupt state of a CPU associated with the illegal instruction exception handler. Often, supervisory privileges maybe required in order to disable or enable the interrupt state of a CPU. However, because an illegal instruction exception handler automatically runs on most operating system with supervisory privileges, it is able to change the interrupt state of the CPU upon detecting an illegal instruction with the special value in a parameter register corresponding to the changing of an interrupt state of the CPU. Thus, in the above described example embodiments wherein software is porting on an operating system, a call to the illegal instruction exception handler may be made to disable the interrupt state of the CPU, and the porting operation of the software may then continue without interrupts being generated by the operating system.

Embodiments of the invention may be used on a variety of systems. For example, the invention may be used in general-purpose computer systems, stand-alone computer systems, and embedded computer systems. Further, embodiments of the invention may be used in conjunction with a variety of software architectures.

The above described library routine and illegal instruction exception handler that may be used in example embodiments of the invention will now be described in conjunction with FIGS. 1-6, which show further details of example embodiments of the invention.

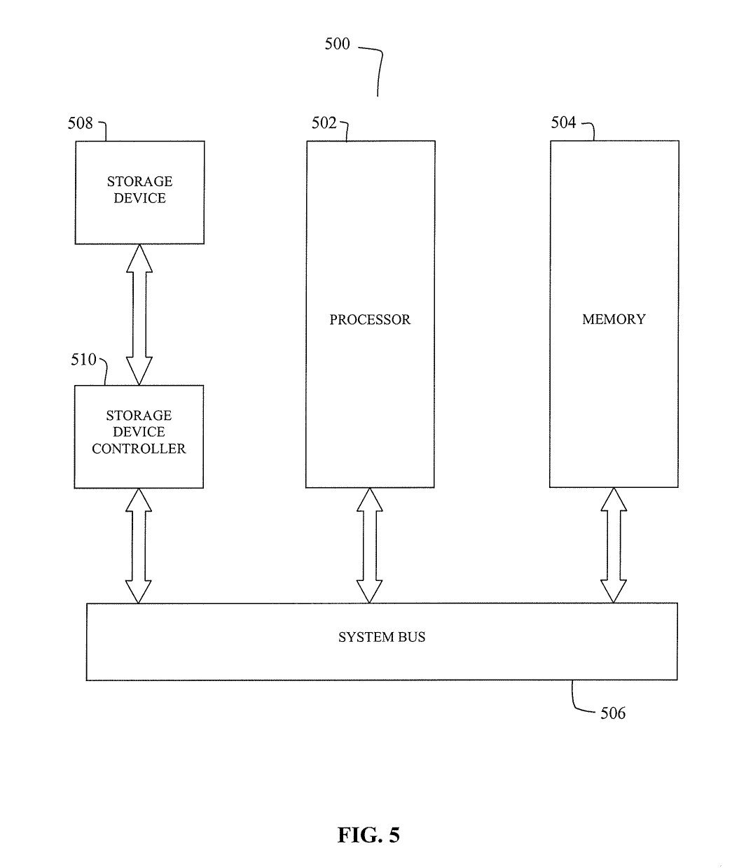

FIG. 5 is an architecture diagram of a data processing system 500 according to an example embodiment of the invention. Data processing system 500 includes a processor 502 coupled to a memory 504 via system bus 506. A storage device 508 having a computer-readable medium is coupled to the processor 502 via a system device controller 510 and system bus 506. The storage device 510 may be used to store, communicate, and read/write data and instructions used to implement the procedures described below in conjunction with FIGS. 1-3. In operation, processor 502 loads instructions from the storage device 510 into memory 504. As described in detail below, processor 502 may then execute aspects in embodiments of the invention such as a programmable code for creating illegal instructions for special values in parameter registers and programmable code for changing a state of processor 502.

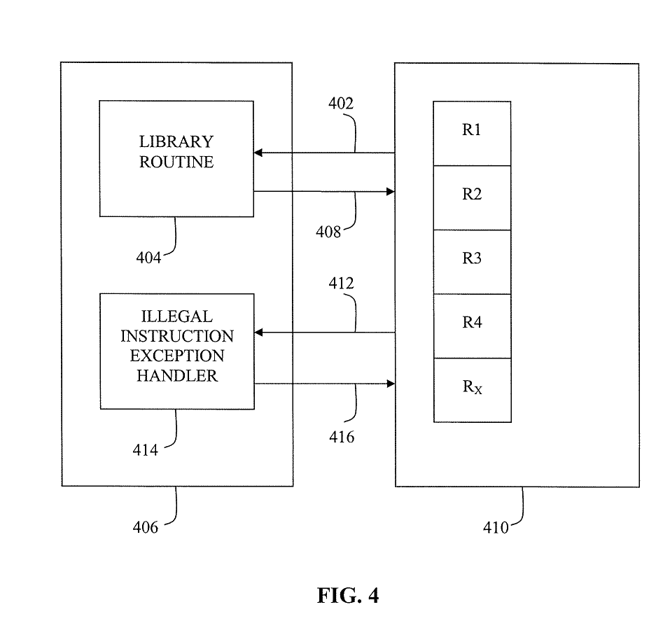

FIG. 4 is a block diagram of a computer system according to an example embodiment of the invention. The computer system shown in FIG. 4 may be used to employ the methods described herein, such as a process wherein the interrupt state of a CPU is disabled. Moreover, the computer system may be used as more specific application in the embodiments of the invention shown in FIGS. 5 and/or 6 (described below).

The computer system includes a CPU 410 which performs a call 402 to a library routine 404 located in a memory 406 of the computer system. As described above, the call 402 may be initiated by software, such as in the case when software is porting on an operating system of the computer system.

As described above, the library routine 404 is configured to recognize the call 402 from the CPU 410. The library routine 404 may create an illegal instruction 408 to load special values in parameter registers on the CPU 410. The illegal instruction 408 is detected by the CPU 410, and the special values are loaded into one or more of registers R1, R2, R3, R4, and RX of the CPU 410. It should be noted that while five registers are shown in CPU 410, the CPU 410 may have any number of registers.

Upon detecting the special values in parameter registers, the CPU 410 may perform a call 412 to an illegal instruction exception handler 414 located in memory 406. As described above, the illegal instruction exception handler 414 may be configured so that upon finding the special values in the parameter registers, the illegal instruction exception handler 414, which is running in supervisory mode, will perform an operation 416 to enable or disable an interrupt state of the CPU 410. Thus, in the case where the call 402 is initiated by software porting on the operating system of the computer system, the software may continue its porting operating with interrupts of the operating system disabled.

It should be noted that while FIG. 4 shows an embodiment of the invention wherein one of the special values in the parameter registers is used to disable an interrupt state of the CPU, in other embodiments, other numbers of special values can be used to disable the interrupt state of the CPU. Also, the components of the system could be the same in other embodiments, such as wherein the interrupt state of the CPU is enabled, or wherein the registers of the CPU are read. In these cases, one (or more) of the special values in the parameter registers signals to the illegal instruction exception handler to perform an operation on the CPU, as described above.

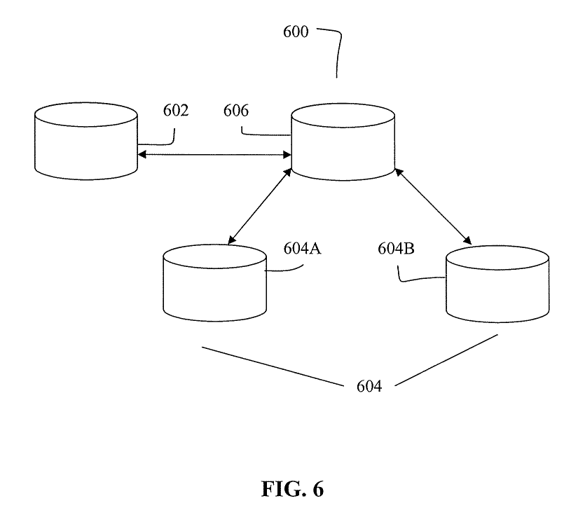

FIGS. 1-3 are flow charts showing procedures according example embodiments of the invention. The description below of these Figures will include references to the elements depicted in FIG. 4. It should be noted, however, that the methods depicted in FIGS. 1-3 could be used in conjunction with other systems, such as those described above in conjunction with FIGS. 5 and 6.

FIG. 1 is a flow chart showing elements according to one example embodiment of the invention, wherein illegal instructions for special values in parameter registers may be used to disable an interrupt state of a CPU 410.

In block 100 of FIG. 1, software that is attempting to port on an operating system calls a library routine 404. As described above, the library routine 404 may be, for example, an application programming interface. As also described above, the software may be, for example, software designed for an operating system that does not support multiple privilege levels, whereas the operating system onto which the software is attempting to port may support multiple privilege levels.

The library routine 404 may, or may not be able to recognize the call 402 from the CPU 410 which is originated from the software attempting to port on the operating system. In block 102, the library routine 404 examines the call 402. If the software is of the type that the library routine 404 recognizes, the library routine 404 creates an illegal instruction for special values in parameter registers 408, as shown in block 104. Alternatively, the library routine 404 may not recognize the call 402 from the software as one indicating the need to create an illegal instruction for special values in parameter registers 408. In such a case, the library routine 404 may create an illegal instruction for normal values in parameter registers 408, as shown in block 106. Note, the term “normal values” refers to any value of a parameter register which may be associated with an illegal instruction other than “special values” described herein.

After either of blocks 104 or 106, the CPU 410 detects the illegal instruction created by the library routine 404, as shown in blocks 108 and 110, respectively. In either case, the CPU 410 then calls the illegal instruction exception handler 414 of the operating system upon detecting the illegal instruction (blocks 108 and 110).

The illegal instruction exception handler 414 called by the CPU 410 after block 108 then recognizes and interprets the illegal instruction containing the special values in parameter registers (block 112). As described above, when the special value parameter registers have been loaded onto the CPU 410 as a result of an illegal instruction from the library routine, the illegal instruction exception handler 414 may interpret one of the special values as indicating that the illegal instruction is intentional, and another of the special values as indicating to disable an interrupt state of the CPU 410. As shown in block 116, the illegal instruction exception handler 414 running in supervisory mode disables the interrupt state of the CPU 410 of the operating system. Then, as shown in block 120, control is returned to the software to allow the porting operation of the software to be completed.

Alternatively, the illegal instruction examined by the illegal instruction exception handler 414 may not include the special values in parameter registers, as shown in block 114. In such a case, the illegal instruction exception handler 414 does not disable the interrupt state of the CPU 410. Instead, the illegal instruction exception handler 414 at block 118 terminates the software attempting to port on the operating system, and at block 122 the illegal instruction exception handler 414 returns control to the operating system.

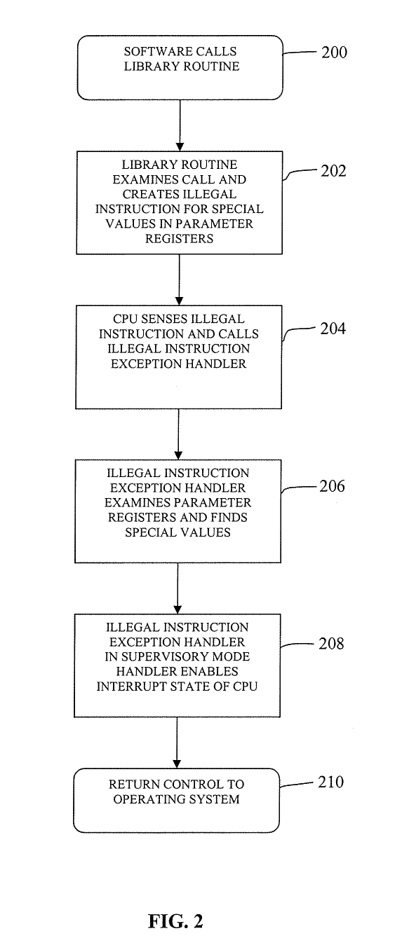

FIG. 2 is a flow chart showing an example embodiment of the invention, wherein an interrupt state of a CPU 410 is enabled after software has finished porting on an operating system. FIG. 2 may follow, for example, the operations depicted in FIG. 1, wherein the interrupt state of the CPU 410 was disabled.

In this case, at block 200 the software calls the library routine 404 that has previously been created or modified, as described above, to create an illegal instruction for special values in parameter registers 408. At block 202, the library routine 404 examines the call 402, and then proceeds to create an illegal instruction for special values in parameter registers 408. In this example embodiment, at least one of the special value parameter registers is used to designate enabling of an interrupt state of the CPU 410.

At block 204 the CPU 410 detects the illegal instruction and calls the illegal instruction exception handler 414. At block 206 the illegal instruction exception handler 414 reads and interprets the special values in parameter registers of the illegal instruction as indicating that the illegal instruction is intentional, and that the interrupt state of the CPU 410 should be enabled. The illegal instruction exception handler 414 running in supervisory mode thereby acts to enable an interrupt state of the CPU 410 of the operating system at block 208, and returns control to the operating system at block 210.

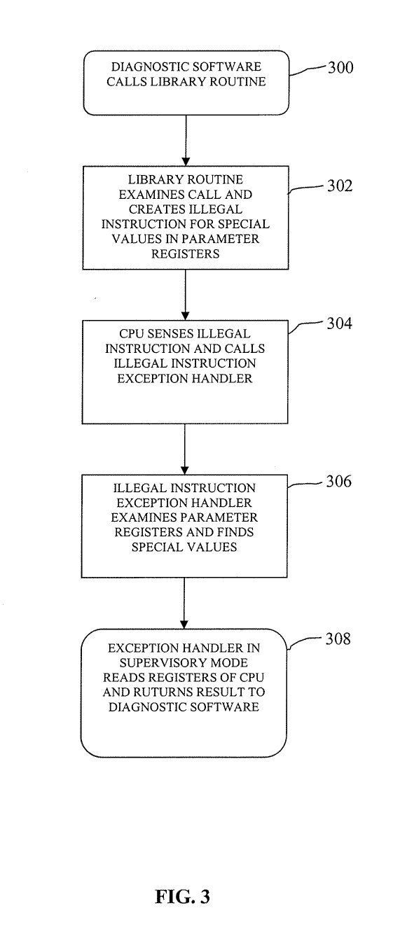

FIG. 3 is a flow chart showing another example embodiment of the invention. In this embodiment, a library routine 404 and illegal instruction exception handler 414 are used to allow diagnostic software to read and output CPU 410 registers to a user. Such diagnostic software may be used, for example, by a technician attempting to determine the processor register version of the CPU 410. In most CPU architectures, a call to read and output a subset of CPU registers requires supervisory privileges. For example, a PowerPC CPU requires supervisory privileges to access the Machine State Register. Therefore, the method as shown in the embodiment of FIG. 3, can enable diagnostic software, which in and of itself may not be granted supervisory privileges on an operating system, to perform an operation of reading registers of the CPU 410, which could not otherwise be read without supervisory privileges.

In block 300, the diagnostic software originates a call 402 from CPU 410 to a library routine 404. The library routine 404 may have been modified, as described above, to recognize the call 402. The library routine 404 in block 302 then can create an illegal instruction for special values in parameter registers 408, with one of the special value parameter registers indicating that the illegal instruction is intentional, and the other special value parameter register indicating that the registers of the CPU 410 should be read and output.

In block 304, the CPU 410 senses the illegal instruction and calls the illegal instruction exception handler 414. The illegal instruction exception handler 414 in block 306 is able to recognize and interpret the special values in parameter registers of the illegal instruction, and in block 308 uses supervisory privileges to read the registers of the CPU 410 and return the result to the diagnostic software. The diagnostic software may, therefore, obtain information the registers of the CPU 410, and output the results to a user.

FIG. 6 illustrates a logical diagram 600 of the modules according to an example embodiment of the invention. The modules may include hardware, circuitry, software, and/or combinations thereof. Logical diagram 600 includes a module 602 that initiates an operation. The module 602 may include, for example, the storage device 508 and/or storage controller 510, described above. Further, the initiating operation by module 602 may correspond to blocks 100, 200, and 300 in FIGS. 1-3. The module 602 communicates with module 606, which in turn communicates with module 604. The modules 606 and 604 may be, for example, a processor 502 and a memory 504, as described above. The module 604 includes two sub-modules 604A and 604B. One of the sub-modules 604A receives the communication from module 606, and in turn performs an operation that is communicated to sub-module 604B through module 606. The communication between modules 604 and 606, may correspond, for example, to blocks 102, 104, 106, 108, 110, 202, 204, 302, and/or 304 in FIGS. 1-3. The receipt of the communication may then cause sub-module 604B to initiate an operation that effects module 606. In example embodiments, the sub-modules may include programmable code such as a library routine 404 and an illegal instruction exception handler 414 (FIG. 4). Further, this operation may correspond, for example, to blocks 112, 114, 116, 118, 120, 122, 208, 210, 306, and/or 308 in FIGS. 1-3.

Although this invention has been described in certain specific embodiments, many additional modifications and variations would be apparent to those skilled in the art. It is therefore to be understood that this invention may be practiced otherwise than as specifically described. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention. Thus, the present embodiments of the invention should be considered in all respects as illustrative and not restrictive, the scope of the invention to be determined by any claims supportable by this application and the claims' equivalents rather than the foregoing description.

Software embodiments of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium,” “computer readable medium” or “machine readable medium” used herein (if at all) shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the processes recited in the claims need not be performed in the order presented.

What is claimed is:

1. A method of changing a state of a processor, comprising:
creating an illegal instruction for special values in parameter registers; and
changing the state of the processor in response to detecting the illegal instruction for special values in parameter registers.

2. A method as set forth in claim 1, wherein a first programmable code creates the illegal instruction for special values in parameter registers, and a second programmable code changes the state of the processor.

3. A method as set forth in claim 2, wherein the first programmable code is a library routine.

4. A method as set forth in claim 2, wherein the second programmable code is an illegal instruction exception hander.

5. A method as set forth in claim 2, further comprising:
porting software on an operating system operating with the processor,
wherein the software calls the first programmable code, and first programmable code creates the illegal instruction for special values in parameter registers upon receiving the call from the software.

6. A method of as set forth in claim 5, wherein the porting software is device driver software.

7. A method as set forth in claim 5, wherein the porting software is diagnostic software.

8. A method as set forth in claim 3, wherein the library routine is initially created with the capability of creating the illegal instruction for special values in parameter registers.

9. A method of as set forth in claim 3, wherein the library routine is modified to include the capability of creating the illegal instruction for special values in parameter registers.

10. A method as set forth in claim 4, wherein the illegal instruction exception handler is initially created with the capability of recognizing the illegal instruction for special values in parameter registers.

11. A method as set forth in claim 4, wherein the illegal instruction exception handler is modified to include the capability of creating illegal instruction for special values in parameter registers.

12. A method as set forth in claim 2, wherein one of the special values of parameter registers in the illegal instruction is used to indicate to the second programmable code that the illegal instruction is intentional.

13. A method as set forth in claim 2, wherein one of the special values of parameter register in the illegal instruction is used to indicate to the second programmable code to enable an interrupt state of the processor.

14. A method as set forth in claim 2, wherein one of the special values of parameter register in the illegal instruction is used to indicate to the second programmable code to disable an interrupt state of the processor.

15. Computer software embodied in a medium readable by a processor, comprising:
a library routine that can create an illegal instruction for special values in parameter registers; and
an illegal instruction exception handler that can detect the illegal instruction for special values in parameter registers, and enable or disable an interrupt state of the processor in response to detecting the illegal instruction for special values in parameter registers.

16. A computer-readable storage medium storing a computer program that is executable by a computer, the program comprising:
a first program code that creates an illegal instruction for special values in parameter registers;
a second program code that receives the illegal instruction for special values in parameter registers and effects a change in a processor associated with the computer.

17. A computer-readable storage medium as set forth in claim 16, wherein the first program code is a library routine.

18. A computer-readable storage medium as set forth in claim 16, wherein the second program code is an illegal instruction exception handler.

19. A computer-readable storage medium as set forth in claim 16, wherein the change effected by the second program code is to enable or disable an interrupt state of the processor.

20. A computer-readable storage medium as set forth in claim 16, wherein the computer is an embedded computer system.

21. A computer-readable storage medium as set forth in claim 16, wherein the computer is a general-purpose computer system.

22. A data processing apparatus, comprising
at least one storage medium storing a library routine and an illegal instruction exception handler; and
a processor coupled to the storage medium, and arranged to execute (i) the library routine to create an illegal instruction for special values in parameter registers, and (ii) the illegal instruction exception handler to change a state of the processor in response to the illegal instruction for special values in parameter registers.
